(19) United States
(12) Patent Application Publication
(10) Pub. No.: US 2012/0078678 A1
(43) Pub. Date: Mar. 29, 2012

(54) METHOD AND SYSTEM FOR ESTIMATION AND ANALYSIS OF OPERATIONAL PARAMETERS IN WORKFLOW PROCESSES

(75) Inventors: Satyabrata Pradhan, PO/Dist.- Sundargarh (IN); Radha Krishna Pisipati, Hyderabad (IN)

(73) Assignee: INFOSYS TECHNOLOGIES LIMITED, Bangalore (IN)

(21) Appl. No.: 12/951,368

(22) Filed: Nov. 22, 2010

(30) Foreign Application Priority Data
Sep. 23, 2010 (IN) 2772/CHE/2010

(51) Int. Cl. G06Q 10/00

(52) U.S. Cl. 705/7.27

(57) ABSTRACT

A system and method for estimation and analysis of operational parameters in workflow processes in order to establish effect of parameters on one or more critical parameters is provided. The method includes creating a Bayesian network including one or more operational nodes representing one or more operational parameters and one or more critical nodes representing one or more critical parameters. The method further includes generating an evidence set based on market events and deducing inferences based on the generated evidence set and Bayesian engine. Inferences are deduced by determining possible discrete states of operational parameters associated with one or more target nodes and their probability distribution values. Deduced inferences are then validated to confirm strength of probability distribution values. Forecasting for a selected operational parameter is performed by obtaining probability distribution of independent parameters and then performing forecasting for the selected parameter using Bayesian locally weighted regression model.

### FIELD OF INVENTION

The present invention relates generally to the field of operations management. More particularly, the present invention implements a method and system for modeling business processes in an organization in order to estimate the effect of one or more operational parameters on organizational workflows.

### BACKGROUND OF THE INVENTION

One of the main aspects of financial research is Operational Risk Management (ORM). Currently available tools in the industry are decision-making tools that help in identifying operational risks and determining the best course of action for an operational incident. For example, in an ORM system in financial domain, risk management is performed before the business quarter to ensure smooth operation of whole process of the company.

A useful knowledge-based approach for performing operational risk management is creating process models of organizational workflows and using computerized analysis tools for estimating effect of operational parameters on workflows. However, currently used models are heavily based on existing knowledge of systems and processes within an organization. These models are not adapted to capture uncertainty in process workflows. In a real life business process scenario, failure in a workflow component may occur due to random reasons which may lead to multiple abnormalities in the workflow. There exists a need to capture uncertainties affecting an organizational workflow.

Moreover, currently used process models are static models that do not use past data efficiently while analyzing a process model. Also, since real-world process data available for analysis is numerical in nature it cannot capture underlying relationships between variables of interest.

In light of the above, there exists a need for an automated system for creating dynamic process models that efficiently capture relationships between operational parameters of the model. Further, the system should be able to capture uncertainty in organizational workflows.

### SUMMARY OF THE INVENTION

A system and method for estimation and analysis of workflow parameters in order to establish the effect of workflow parameters on one or more critical parameters is provided. The method includes collecting one or more operational parameters related to the workflow process. The method further includes creating a Bayesian network comprising one or more operational nodes representing the one or more operational parameters and one or more critical nodes representing the one or more critical parameters. After creation of Bayesian network, one or more conditional probability tables corresponding to the one or more operational nodes and the one or more critical nodes are created and thereafter a Bayesian engine using the Bayesian network structure is generated. An evidence set based on market events is then generated and inferences based on the generated evidence set, and the Bayesian engine are deduced. In an embodiment of the present invention, inferences are deduced by determining possible discrete states of operational parameters associated with one or more target nodes and their probability distribution values. The deduced inferences are then validated to conform strength of probability distribution values.

In various embodiments of the present invention, collecting one or more operational parameters includes extracting the one or more operational parameters from a database, wherein the one or more operational parameters comprises at least one of macroeconomic parameters, industry-specific parameters and organization-specific parameters.

In various embodiments of the present invention, generating a Bayesian engine comprises extracting a training dataset for populating conditional probability tables associated with each node of the Bayesian network, filling up missing values in the training dataset based on mathematical regression techniques, discretizing operational nodes and critical nodes and performing parameter learning of discrete dataset of each node. In an embodiment of the present invention, operational nodes and critical nodes are discretized using impurity based discretization method.

In an embodiment of the present invention, parameter learning of discrete dataset of each node is performed by executing Maximum Likelihood Estimation method.

In various embodiments of the present invention, the method comprises, prior to generating an evidence set, determining whether additional datasets are available for facilitating creation of a Bayesian network. In case it is determined that additional datasets are available, an intermediate conditional probability table for each operational node and each critical node is generated. Further, the one or more conditional probability tables based on intermediate conditional probability tables and the existing Bayesian engine are updated.

In various embodiments of the present invention, it is determined whether forecasting is to be performed for a selected operational parameter. Independent operational parameters are then collected from the Bayesian network for performing forecasting. Probability distribution of independent parameters is obtained and forecasting is performed using Bayesian locally weighted regression model. Bayesian locally weighted regression model is implemented using seasonality based forecasting algorithm. In an exemplary embodiment, Bayesian locally weighted regression model is implemented using seasonality based forecasting algorithm with business cycle.

In an embodiment of the present invention, a system for analysis of one or more operational parameters in an organizational workflow process in order to determine their effect on one or more critical parameters includes a database structured to store templates of Bayesian Networks corresponding to one or more business domains and a Bayesian network module adapted to import an appropriate template from the database and customize the template to create a Bayesian network comprising a plurality of nodes corresponding to the one or more operational parameters and the one or more critical parameters. Bayesian network module is further configured to generate conditional probability tables for the plurality of nodes.

In an embodiment of the present invention, the system of the invention includes a Data Processing Unit configured to convert operational parameters associated with the plurality of nodes into discretized variables and a Incremental Learning Unit configured to generate intermediate conditional probability tables corresponding to the plurality of nodes and further configured to update existing conditional probability tables based on the intermediate conditional probability tables. The system of the invention further comprises a Network Troubleshooting Unit configured to incorporate information from training dataset for facilitating creation of Bayesian network and Inference Unit configured to utilize evidence set generated from market events and information stored in conditional probability tables to deduce inferences for determining effect of one or more operational parameters on the one or more critical parameters.

In an embodiment of the present invention, the system of the invention comprises a forecasting module operating to project current status and forecast future values of one or more parameters related to organizational workflow process based on current market events.

### BRIEF DESCRIPTION OF THE ACCOMPANYING DRAWINGS

The present invention is described by way of embodiments illustrated in the accompanying drawings wherein:

FIG. 1 illustrates an exemplary Bayesian network created for the purpose of modeling a business process, in accordance with an embodiment of the present invention.

FIGS. 2 and 3 illustrate a flowchart depicting a method for determining effect of one or more operational parameters of an organizational workflow on critical parameters associated with the workflow, in accordance with an embodiment of the present invention.

FIG. 4 illustrates block diagram of a system for determining effect of one or more operational parameters of an organizational workflow on critical parameters associated with the workflow, in accordance with an embodiment of the present invention.

FIGS. 5, 6 and 7 illustrate screenshots of a software tool implementing estimation and analysis of operational parameters in workflow processes. FIG. 5 illustrates an exemplary Bayesian network 500 implemented by the software tool, in accordance with an embodiment of the present invention.

FIGS. 8 and 9 illustrate screenshots of a software tool implementing forecasting of values of operational parameters based on current market events.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

Exemplary embodiments of the methods, systems and computer program products described herein provide means for modeling uncertain knowledge in a workflow process using a Bayesian network and additionally, provide reasoning in case of uncertain events. In various embodiments of the present invention, a Bayesian network is constructed in order to create causal relationships between various operational parameters in an organization. Further, the Bayesian network is provided with capabilities to include external parameters contributing critically to the workflow process. Furthermore, the Bayesian network is provided with forecasting capabilities for the purpose of anticipating operational effects of change or addition in one or more parameters.

In exemplary embodiments of the present invention, methods, systems and computer program products described herein provide a tool with templates of Bayesian Networks corresponding to different business domains. Examples of business domains may include, but are not limited to, specific industries such as information technology, transportation, semiconductors, aviation, oil and gas, automobiles, petrochemicals and the like. A particular template corresponding to a generalized business domain has a standard format with common features. For creating structure of a Bayesian network corresponding to a particular organization, the template is customized manually by a domain expert. The method and system of the invention further provides capabilities for adapting the Bayesian network to incremental learning based on events affecting organizational workflow.

In various embodiments of the present invention, the method and system of the present invention is implemented for analyzing an organization's financial workflow and drawing reasoning as well as projecting root cause/effect(s) in critical scenarios. The present invention can also be implemented to diverse fields like aerospace & defence, high technology, retail environments, banks and insurance companies in order to ascertain root cause/effects of any aberrations or deviations in their processes or procedures.

The present invention would now be discussed in context of embodiments as illustrated in the accompanying drawings.

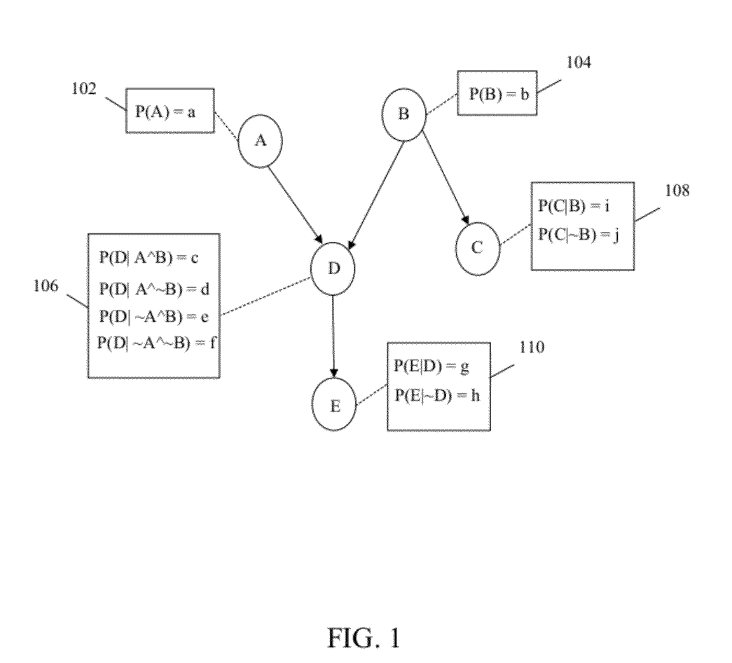

FIG. 1 illustrates an exemplary Bayesian network created for the purpose of modeling a business process, in accordance with an embodiment of the present invention. The system and method of the present invention utilizes an approach of creating a Bayesian network corresponding to an organizational workflow process. A Bayesian network is a directed acyclic graph which encodes probabilistic relationships among nodes in the graph. Nodes in the graph represent variables in a causal system, whereas edges (arrows) represent direct causal relations between the variables. With respect to the present invention, each node represents an operational parameter of a workflow, which is the variable with respect to an organizational workflow process. Typically, operational parameters are specific to type of organization. For example, for a petrochemical company, basic selling price of oil is a critical operational parameter that may be dependant on internal company-specific parameters such as costs associated with machinery, raw materials, refining, employee salaries, administrative costs. Further, the selling price of oil is also dependant on external parameters such as crude oil price, Gross Domestic Product (GDP) etc. Therefore, in accordance with various embodiments of the present invention, for determining probabilistic relationships between the critical operational parameter and other organizational parameters, a Bayesian network is constructed by connecting a node representing critical operational parameter (hereinafter referred to as critical node) to nodes representing one or more operational parameters directly influencing the critical parameter (hereinafter referred to as Operational nodes). The edges connecting a critical node to one or more operational nodes directly influencing the critical node indicate extent of dependencies of critical node on the one or more operational nodes. Further, a conditional probability table corresponding to each node in the Bayesian network is created and maintained. A conditional probability table lists probabilities of occurrence of a condition associated with a node for each possible combination of parent node values influencing the particular node. The figure shows an exemplary Bayesian network wherein the nodes A, B, C, D and E have CPTs created corresponding to each node. As shown in the figure, the CPTs 102, 104, 106, 108 and 110 are created corresponding to the nodes A, B, C, D and E respectively. With reference to the present invention, CPTs associated with nodes are used for building a Bayesian Engine, as described later in the application. The Bayesian Engine thus constructed is a knowledge model of an organization's workflow process and can be used for forecasting values of operational parameters based on current market events.

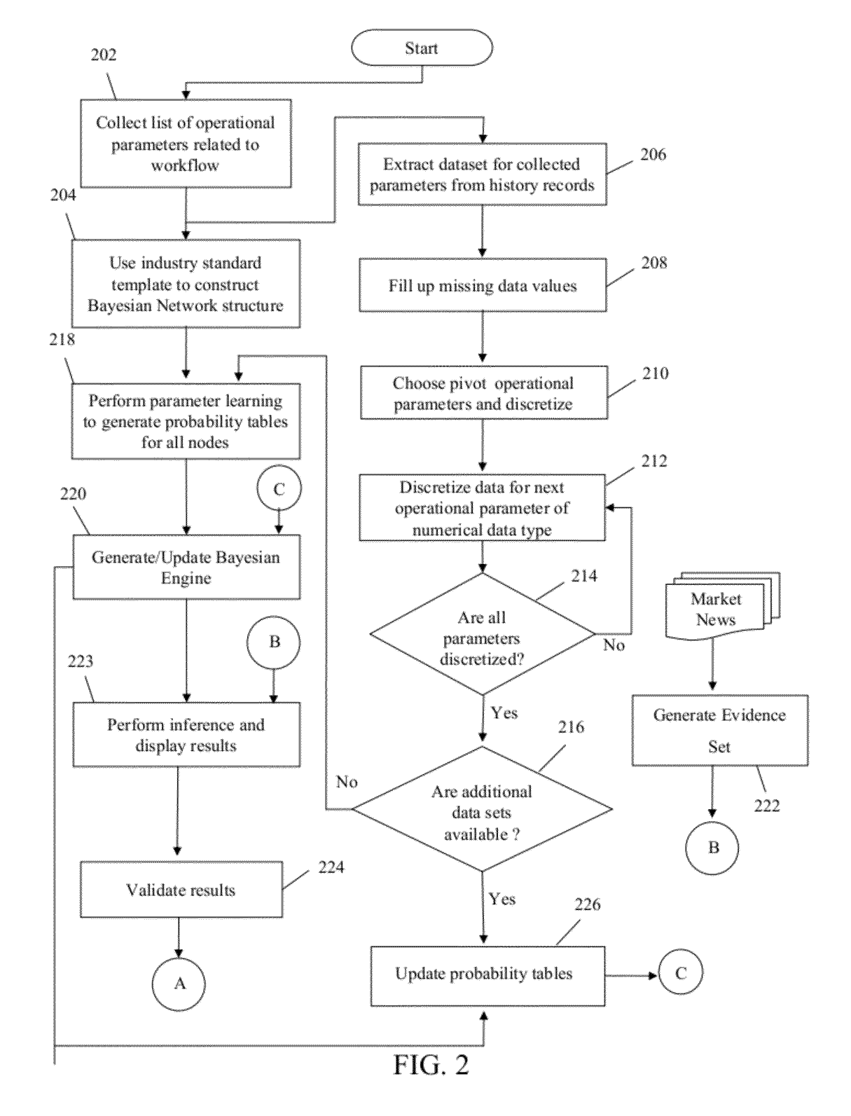

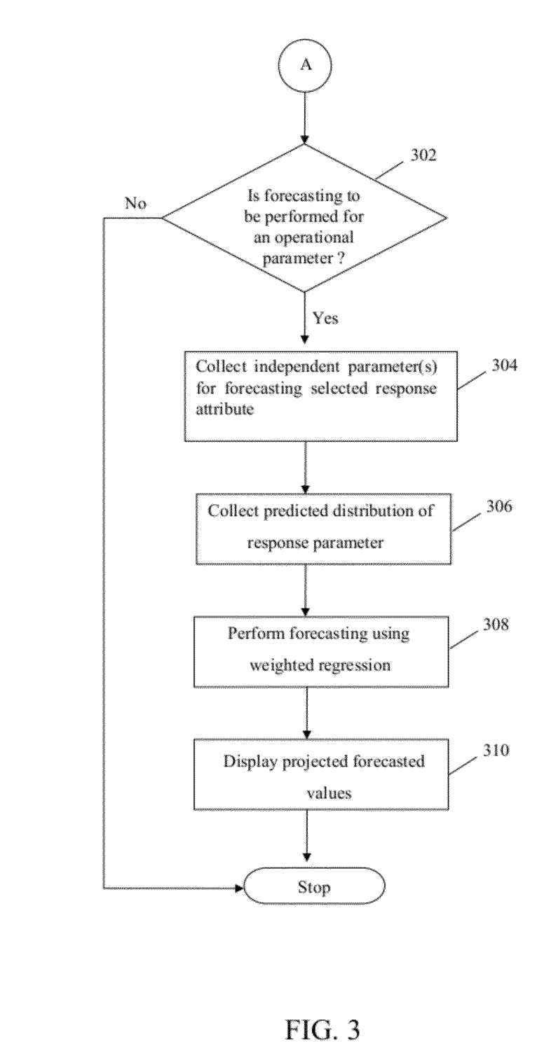

FIGS. 2 and 3 illustrate a flowchart depicting a method for determining effect of one or more operational parameters of an organizational workflow on critical parameters associated with the workflow, in accordance with an embodiment of the present invention. The system and method of the present invention utilizes an approach for creating a Bayesian network corresponding to an organizational workflow process. Following the creation of Bayesian network, inferences are drawn for ascertaining effect of one or more operational parameters of the workflow on critical parameters. The following steps represent the process flow of the method of the invention.

For a particular organizational workflow, at step 202, list of operational parameters corresponding to the workflow are collected by extracting them from a database. In an embodiment of the present invention, the database comprises a plurality of operational parameters corresponding to multiple industries or multiple workflows. In an exemplary embodiment of the present invention, the operational parameters stored in a database are categorized according to their level of granularity. Parameters affecting an organizational workflow are primarily of three types with different granular levels: Macroeconomic parameters, Industry-specific parameters and Organization-specific parameters. Macroeconomic parameters are country wide attributes that are commonly linked to any type of industry operating within a country, whereas industry-specific parameters are linked to all companies within a particular industry. As an exemplary workflow process in an organization involved in real estate construction, the macroeconomic parameters that may affect the workflow process include Gross Domestic Product (GDP) of the country, wealth factor etc. Industry-specific parameters that may affect the organizational workflow include land cost, Retail Prime Lending Rate (RPLR) of loans acquired for construction, raw material cost etc. Further, parameters specific to the organization that may affect the workflow include operating income, Sales & revenue, Interest income, net income etc. In addition to storing parameters in the database, pre-defined Bayesian network templates corresponding to specific type of industries may also be stored in the database. The use of pre-defined network templates enables ease of effort in constructing a Bayesian network corresponding to a particular workflow.

Following the collection of the operational parameters at step 202, a Bayesian network structure corresponding to the workflow is constructed at step 204. In an embodiment of the present invention, an industry standard template corresponding to organizational workflow stored in the database is used to create the Bayesian network structure manually. As described in conjunction with FIG. 1, the Bayesian network structure is created by representing operational parameters with network nodes connected to each other by edges. Corresponding to the step of creating a Bayesian network structure, at step 206, training dataset associated with the collected parameters is extracted from history records in the database. A training dataset is used to train the Bayesian network structure for populating conditional probability tables associated with each node of the network. A training dataset may include a collection of past records on a time horizon where each record has multiple fields. Each field corresponds to a recorded value of a unique operational parameter in the Bayesian network for a specific time period. In various embodiments of the present invention, the training dataset may contain missing values. One or more fields in a record might get missed due to various reasons such as, but not limited to, error in system that records the values at real time, fault in sensor used for data collection etc. Also some operational parameters that may have been introduced lately to work flow might get missed.

At step 208, the missing values are filled up based on mathematical regression techniques for completing the training dataset. A Bayesian network requires discrete form of data for subjective analysis. Hence, numerical data of the training dataset is converted into discrete form. At step 210, a business analyst selects one or more pivot operational parameters. Nodes corresponding to the one or more pivot operational parameters (henceforth known as pivot nodes) are provided with inputs by the business analyst in order to execute the discretization process. In an embodiment of the present invention, an impurity based discretization process is used for discretizing the Bayesian network. After selecting the one or more pivot nodes, the business analyst provides inputs such as number of discrete states required for each node in the network. By way of example, the business analyst can specify the discrete states as High, Medium and Low. In an embodiment of the present invention, an equal width partition based discretization method with adjustable partition levels is used for discretizing the selected pivot node. Once the selected node is discretized, the method and system of the invention traverses all nodes in the Bayesian network. At step 212 an impurity based discretization method is used for discretizing next node selected for discretization.

In an exemplary embodiment of the present invention, the impurity based discretization method is executed by the following method steps:

Step 1: Starting from the discretized pivot node, each node of the Bayesian network is processed using Depth First Search algorithm and in each step, if the node is continuous then it is discretized by selecting a suitable class variable in discrete form. For the purpose of selecting a class variable, the method of the invention uses nodes adjacent to the node to be discretized as class variables. In an exemplary embodiment of the present invention, let node D (FIG. 1) is a continuous node that needs to be discretized. Consequently, operational parameter corresponding to the adjacent node A can be used as a class variable. To find out the best class variable to be used for a node, an Information Gain measure is calculated by the following formula:

Gain(V,T)=Info(T)−Info(V,T) (1)

where T is class variable corresponding to the adjacent node and V is the continuous variable corresponding to the node that needs to be discretized. Here Info(T) is entropy measure. Entropy measure is a measure of purity or impurity associated with a variable. High impurity means that sampling is performed from a uniform distribution. For the purpose of selecting nodes to be discretized as class variables, combination of nodes that maximizes information gain for each class variable should be determined. With respect to information gain, information represents data associated with a class variable that is used by the Bayesian network to ascertain effect of operational parameters on critical parameters.

The entropy measure, Info(T) is defined as:

$$Info ( T ) = {\sum }_{t = 1}^{n} {p}_{t} = log ( {p}_{t} ) \\ where {\sum }_{t = 1}^{n} {p}_{t} = ( {p}_{1} , {p}_{2} , {p}_{3} , … , {p}_{n} ) \qquad ( 2 )$$

is the probability distribution of class variable T. The entropy after the split i.e. Info(V,T) or a given k-partition of V which divides the original class variables record set into T=T₁, T₂, T₃ . . . Tₖ is defined as:

$$Info ( V , T ) = {\sum }_{f = 1}^{k} \frac{\vert {T}_{f} \vert}{\vert {T}_{k} \vert} Info ( {T}_{f} ) \qquad ( 3 )$$

In an embodiment of the present invention, since split is directly proportional to gain, split for which gain is highest is to be chosen. Since the entropy measure, Info(T) is fixed, for maximizing Information Gain measure, Info(V,T) needs to be reduced. In an embodiment of the present invention, Info(V,T) can be reduced by properly choosing splitting points in the variable ‘V’ so that each entropy term Info(Tₗ) will be reduced, which further reduces Info(V,T). For the purpose of discretizing the entire Bayesian network, all dependencies of a continuous variable are captured from adjacent nodes which can be considered to be candidate class variables. Candidate class variables are discrete adjacent nodes of a continuous node from which a right subset of nodes are chosen that optimizes the discretization process. In an embodiment of the present invention, a Principal Direction Divisive Partitioning (PDDP) algorithm is utilized for analyzing strength of candidate class variables.

Following the selection of a set of class variables S, values in node V are sorted and class nodes in set S are set accordingly. Subsequently, all possible cut points for each class node in S are determined. After the determination of cut points, a proposed method is used to pre-store entropy measure of each possible valid partition in a triangular matrix (Entropy Matrix) corresponding to each class node in set S. Entropy is a measure of uncertainty associated with a random variable. In an embodiment of the present invention, the total number of computations required to store all entropy measures is

$$( \frac{n * ( n + 1 ) - k * ( k - 1 )}{2}$$

which is in order of O(n^{k}) compared to O(kn^{k}) if all computations of entropies are carried out at run time. Then, a proposed hash table based dynamic approach is implemented to select k−1 cut points in order to find best k-partitions. Using the dynamic approach, number of accesses to the Entropy Matrix is reduced to save more computing time in general and increase overall performance of the proposed method.

In an embodiment of the present invention, in order to select best partition, firstly a hash table containing gain values for each class variable is generated. Then, for the number of class variables considered for a partition, a partition that maximizes gain value for all class variables is chosen. Finally Euclidean distance between highest gain point and each partition is computed and the point having shortest distance is considered as the final partition. After the partition points are decided, numerical data is converted into corresponding discrete states according to the partition ranges derived.

At step 214, it is determined whether all operational parameters are discretized. If it is determined that all operational parameters are not discretized, the process flow is reverted to step 212 for discretizing the nodes. However, if it is determined that all nodes are discretized, it is determined at step 216 whether additional datasets or records are available for creating a Bayesian network. In a scenario where no additional records or datasets are available for analysis, at step 218, parameter learning of Bayesian network is performed on discrete dataset of each node for generating CPT corresponding to each node. In an embodiment of the present invention, Maximum Likelihood Estimation (MLE) method is executed for parameter learning of Bayesian network. Thereafter, at step 220 a Bayesian engine comprising CPTs corresponding to operational nodes and critical nodes of Bayesian network is created.

However, the MLE method for parameter learning produces CPTs for each node in the Bayesian network having fractional numbers. In an exemplary embodiment of the present invention, a CPT for a node X having parents Y1 and Y2 is illustrated in the following table:

TABLE 1
CONDITIONAL PROBABILITY TABLE (CPT)

| N = 100 | X = T | X = F |
|---|---|---|
| Y1 = T, Y2 = T | 0.8 | 0.2 |
| Y1 = F, Y2 = T | 0.4 | 0.6 |
| Y1 = T, Y2 = F | 0.67 | 0.33 |
| Y1 = F, Y2 = F | 0.2 | 0.8 |

As shown in TABLE 1, for the condition Y1=TRUE and Y2=TRUE probability of condition associated with node X to be TRUE is 0.8, whereas for the condition Y1=FALSE and Y2=TRUE probability of condition associated with node X to be TRUE is 0.4 for. One of the disadvantages of storing CPTs as TABLE 1 is that since the results show only fractional numbers for node X corresponding to a certain number of records (in this case N=100), when additional records are added to the database, the MLE algorithm has to be re-run again in order to generate new probability values. One of the key features of invention is its capability for adapting Bayesian network to incremental learning based on events affecting organizational workflow. In certain scenarios, new records may be added to database based on change in values of operational parameters or addition to operational parameters. Hence, in various embodiments of the present invention, an Intermediate Conditional Probability Table (ICPT) is used for the purpose of performing parameter learning. An ICPT comprises data specifying number of occurrences of conditions associated with dependent nodes. For each dependent node, data specified by ICPT is based on number of records of unique combinations of parent nodes influencing the dependent node. Thus, as number of records of unique combinations of parent nodes increases due to addition of new records, ICPT corresponding to the Bayesian network changes. The table below illustrates an ICPT corresponding to a CPT:

TABLE 2

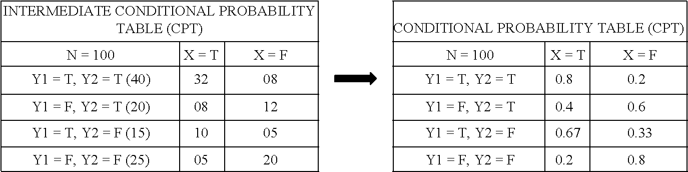

Whenever new records are added to database, only ICPT needs to be updated for each new addition, and the CPT is updated only when required for analysis.

In an embodiment of the present invention, as the Bayesian network at step 204 is constructed manually by a domain expert, there are chances of contradictions arising between the network designed and training dataset. The training dataset may not support all links created between nodes on the network. Moreover, the dataset may support some additional link that needs to be established between nodes. Hence, a Monte-Carlo based troubleshooting simulation is implemented using Gibbs Sampling which finds plausible interactions between nodes in the Bayesian network The simulation procedure produces a matrix A, which describes the strength of association between each pair of nodes in the Bayesian network. In an example, Aᵢⱼ is average association value j^{th} node, given the i^{th} node. The value Aᵢⱼ varies from 0 to 1, where higher value represents better association. In an embodiment of the present invention, by setting suitable threshold value, strength of existing edges among nodes is checked and the network is modified by deleting existing edges or adding new edges between nodes according to their values in the matrix A.

If at step 216, it is determined that additional datasets or records are available for creating a Bayesian network, then at step 226, ICPTs are generated based on the additional datasets and existing CPTs are updated. For updating the CPTs, inputs from existing Bayesian engine at step 220 may be used. The updated CPTs illustrate effect of addition of new records on operational parameters. The information in the updated CPTs is then used for updation of Bayesian engine at step 220.

In an embodiment of the present invention, an evidence set is generated based on market events at step 222. The evidence set may comprise information on one or more operational parameters of the Bayesian network along with their values/states. At step 223, information stored in CPTs of the Bayesian engine along with the evidence set is used to deduce inferences for critical subjective analysis on one or more important operational parameters. In an embodiment of the present invention, one or more target nodes are chosen based on critical operational parameters associated with the nodes. Then, using statistical algorithms, inferences are drawn that demonstrate effect of other operational parameters on critical operational parameter associated with the one or more target nodes. A Junction Tree Algorithm may be implemented for utilizing the generated evidence set for determining possible states for operational parameters associated with the one or more target nodes along with their probability distribution. In an exemplary embodiment of the present invention, in a Bayesian network representing a supply chain workflow process, one of the target nodes may be an operational parameter representing inventory management and the effect of other operational parameters influencing inventory management is ascertained by drawing inferences using Junction tree algorithm. Inferences drawn helps in decision making in critical market situations.

As described earlier, organizations related to a common industry will have common nodes in their Bayesian structure. Based on a particular market scenario, if a common evidence set corresponding to common nodes is set, then the impact of evidence set on the Bayesian structure of multiple organizations can be ascertained. This may assist a business analyst to compare working policies of various organizations. In an exemplary embodiment of the present invention, inferences performed at step 223 illustrate probability distribution among possible discrete states of a target node. Therefore, the inferences do not suggest confirmed states of a target node but they demonstrate chances of occurrence of each state with probability values associated with them. Thus, strength of inference results needs to be validated in order to provide optimum results that can be relied upon by a business analyst.

As the evidence set comprises states/values of multiple operational parameters, a check needs to be performed in the training dataset for ascertaining whether a particular evidence has happened in the past. This can be ascertained by determining the probability that a particular evidence has occurred in the past. In an embodiment of the present invention, at step 224, joint probability of supplied evidence set is computed with respect to multiple operational parameters, which indicates chances of present market scenario that has already happened in the past. In case, the computed joint probability is high, validity of inference results is strengthened.

In another embodiment of the present invention, in order to confirm inference results, confidence limit of the inference result for probability value of each state corresponding to a target node is computed. For calculating the confidence limit, a computer simulation is performed wherein conditional probability values of nodes which are immediate parent or child of target node are calculated and their effect on target node's CPT is determined. In an exemplary embodiment of the present invention, the simulation is performed “n” number of times and confidence limit is calculated using Area Under Curve (AOC). In an example, if according to the inference result, a target node X=High (States={High, Medium, Low}) is having a probability of 0.75. The confidence limit method may say “Probability of X=High may vary from 0.69 to 0.77 with a confidence of 90%. Thus, if the confidence is high and the range is on lower side, inference results will be better.

In an organizational workflow process, there may exist a need to perform forecasting related to a specific operational parameter, in addition to subjective analysis. At step 302, it is determined whether forecasting is to be performed for a particular operational parameter. At step 304, independent operational parameters from the Bayesian network are collected for performing forecasting for a selected operational parameter. Thereafter, at step 308, probability distribution for independent operational parameters is obtained from inferences drawn at step 223. In various embodiments of the present invention, using the probability distribution, Bayesian locally weighted regression method is used for performing the forecasting. Algorithms used for performing forecasting include seasonality based forecasting algorithms. A seasonality based forecasting algorithm uses a periodic pattern in time series data for forecasting, wherein the seasonality is filtered before forecasting is performed. After performing the forecasting, seasonality is added later to preserve periodicity. In various embodiments of the present invention, seasonality with business cycle algorithms is used for performing forecasting. A business cycle is a time window for a forecasting algorithm i.e. a length up to which a forecasting algorithm should consider past data in order to predict future data. Thus, a business cycle limits amount of past data that can be used for performing forecasting, as it is believed that data beyond the business cycle may not be useful to predict future values. In an embodiment of the present invention, after performing forecasting, projected forecasted values are displayed at step 310.

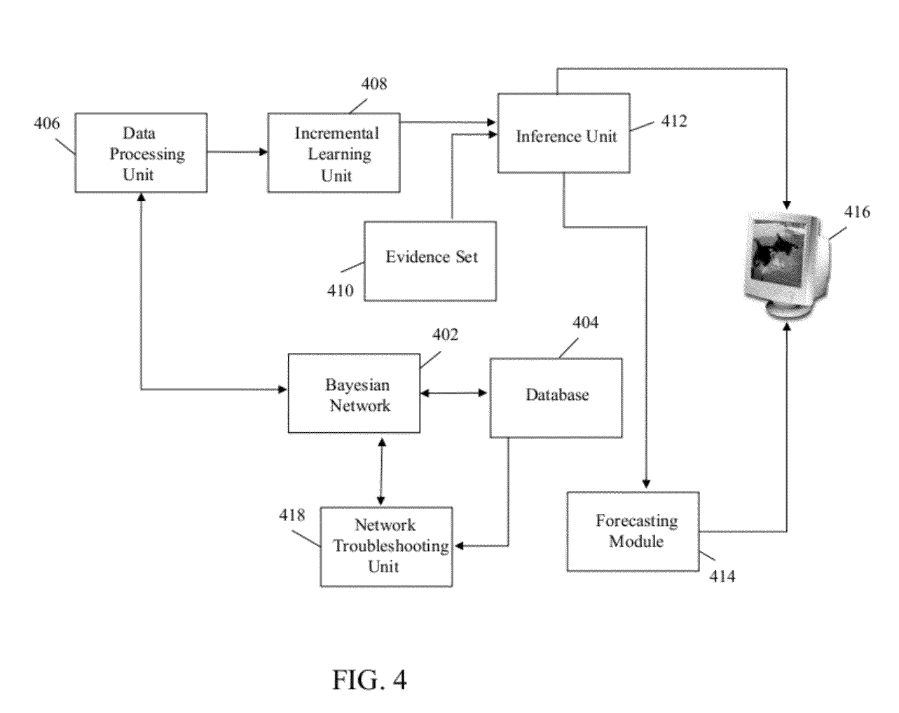

FIG. 4 illustrates block diagram of a system 400 for determining effect of one or more operational parameters of an organizational workflow on critical parameters associated with the workflow. As shown in the figure, a Bayesian Network 402 is a software module representing a Bayesian network created corresponding to the organizational workflow process. In an embodiment of the present invention, the system 400 stores templates of Bayesian Networks corresponding to different business domains in a Database 404. A template of a Bayesian Network for a business domain such as financial domain is a generic probabilistic model including operational parameters specific to the financial domain represented as nodes. An exemplary operational parameter may be “Credit Rating” of customer of a bank providing loans. An exemplary template of Bayesian Network may illustrate “Credit Rating” as a child node with parent nodes connected to it through edges.

For representing an organizational workflow process in a particular domain such as financial domain, an appropriate template is imported from the Database 404 by the Bayesian network module 402. The imported template is then customized by the module 402 to create a precise Bayesian network corresponding to the organizational workflow process to be analyzed. Customizing includes adding or deleting nodes representing operational parameters in order to capture all dependencies of critical operational parameters. Typically, operational parameters represented by the nodes are variables that are continuous in nature. For performing analysis based on the created Bayesian network, nodes of the network are required to be discretized. In various embodiments of the present invention, a Data Processing Unit 406 is configured to convert operational parameters associated with a node to discretized format. While discretizing an operational parameter, interdependencies among nodes influencing the node are taken into account by the system of the invention. In an embodiment of the present invention, an impurity based discretization method is used for discretizing the nodes. Following the discretization of nodes, discretized data is provided to the Bayesian network module 402 which generates CPTs for each node. The CPTs for each node are then stored in the Database 404.

A typical organizational workflow is influenced by changes in operational parameters which are accounted for by an Incremental Learning Unit 408. The Incremental Learning Unit 408 comprises software code adapted to use new records associated with the workflow for generating ICPTs for each node which in turn updates the CPTs associated with the nodes. In an embodiment of the present invention, based on CPTs and Evidence Set 410, an Inference Unit 412 is configured to deduce inferences for critical subjective analysis on one or more important operational parameters. Results of inferences performed by the Inference Unit 412 are displayed on a Front-end interface 416. Further, the Inference Unit 412 is configured to validate the inference results.

The inference results are provided to a Forecasting Module 414. In addition to subjective analysis of a targeted operational parameter, a business analyst may be interested in projection of targeted operational parameter with respect to changes in other operational parameters influencing the targeted operational parameter. The Forecasting Module 414 is adapted to forecast values of operational parameters based on current market events. In an embodiment of the present invention, a Bayesian locally weighted regression method is used to perform forecasting of the targeted operational parameter. Regression analysis is the process of constructing a mathematical model or function that can be used to predict or determine one variable by another variable or collection of variables (predictors). In an embodiment of the present invention, in the Bayesian network 402, a critical node is chosen as a targeted parameter and one or more nodes representing parameters influencing the critical node parameter are selected using correlation techniques. The selected nodes are nodes having full data for performing regression analysis. Correlation is a measure of degree of relationship of two variables that may be expressed in the range −1 to 0 to +1. The following steps may be used for performing correlation: Firstly, an appropriate set of nodes are selected as predictor nodes based on the correlation analysis. Secondly, regression analysis is used to find an appropriate function of predictor nodes that best fits data of an operational parameter with missing values. In an embodiment of the present invention, a relationship is established between a targeted operational parameter and predictor nodes using R^{z} values and correlation values corresponding to the regression.

Instead of using multiple regression, a Bayesian locally weighted regression model is used to incorporate probability distribution of targeted operational parameter from inference results. A final regression model is used to forecast time bound results corresponding to a targeted operational parameter. Results of the forecasting module may be presented on the Front-End interface 416.

As shown in the figure, the system of the present invention implements a Network Troubleshooting Unit 418 that facilitates creation of Bayesian network based on information obtained from training dataset. In an embodiment of the present invention, since a preliminary Bayesian network structure is manually designed by a domain expert, there are chances of contradictions arising between the network structure designed and the discrete training dataset. The training dataset may not support all the links created between the nodes on the network. Moreover the dataset may support additional links that need to be established between nodes. The Network Troubleshooting Unit 418 implements a Monte-Carlo based troubleshooting procedure using Gibbs Sampling. In an exemplary embodiment of the present invention, this procedure produces a matrix that describes the strength of association between each pair of nodes in a Bayesian network. For example, for a node j, the strength of association with respect to another node i is specified by a value Aij in the matrix. Aij varies from 0 to 1 and a value on the higher side represents stronger association between the nodes i and j. A suitable threshold value is set and the strength of existing edges among nodes of the Bayesian network is ascertained. Subsequently, based on information in the training dataset, new edges are added and existing edges are either modified or deleted by modifying values stored in the matrix.

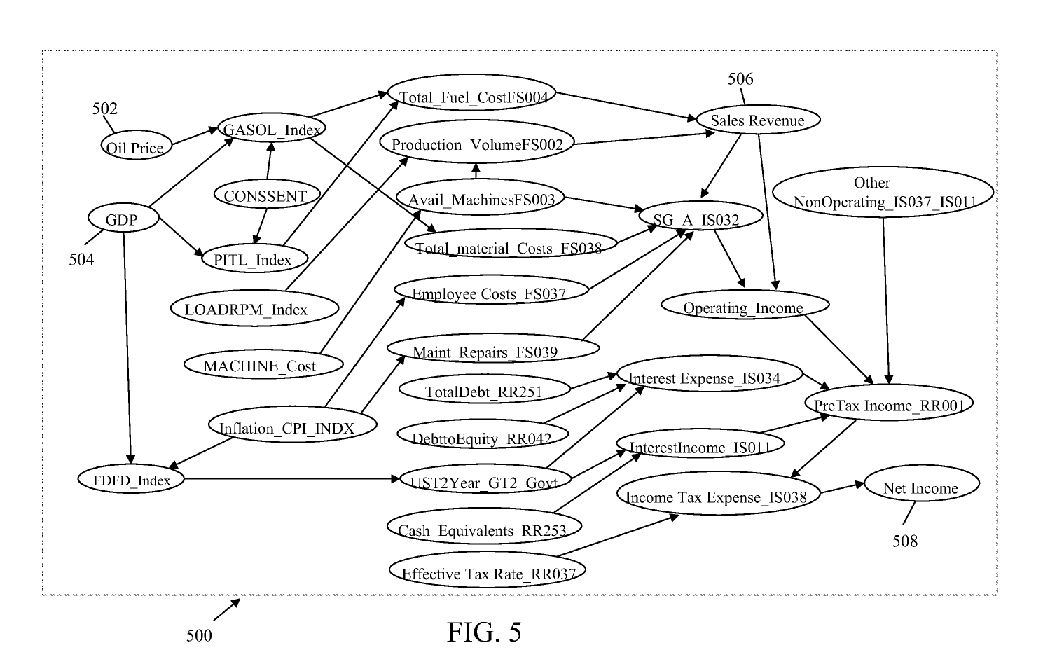

FIG. 5 is a screenshot illustrating an exemplary Bayesian network 500 implemented by a software tool, in accordance with an embodiment of the present invention. The nodes oil price 502 and GDP 504 represent independent operational parameters whereas the nodes Sales Revenue 506 and Net Income 508 represent critical operational parameters. In an embodiment of the present invention, past records with company-specific data is loaded onto Bayesian network 500 in order to create a preliminary structure of Bayesian network.

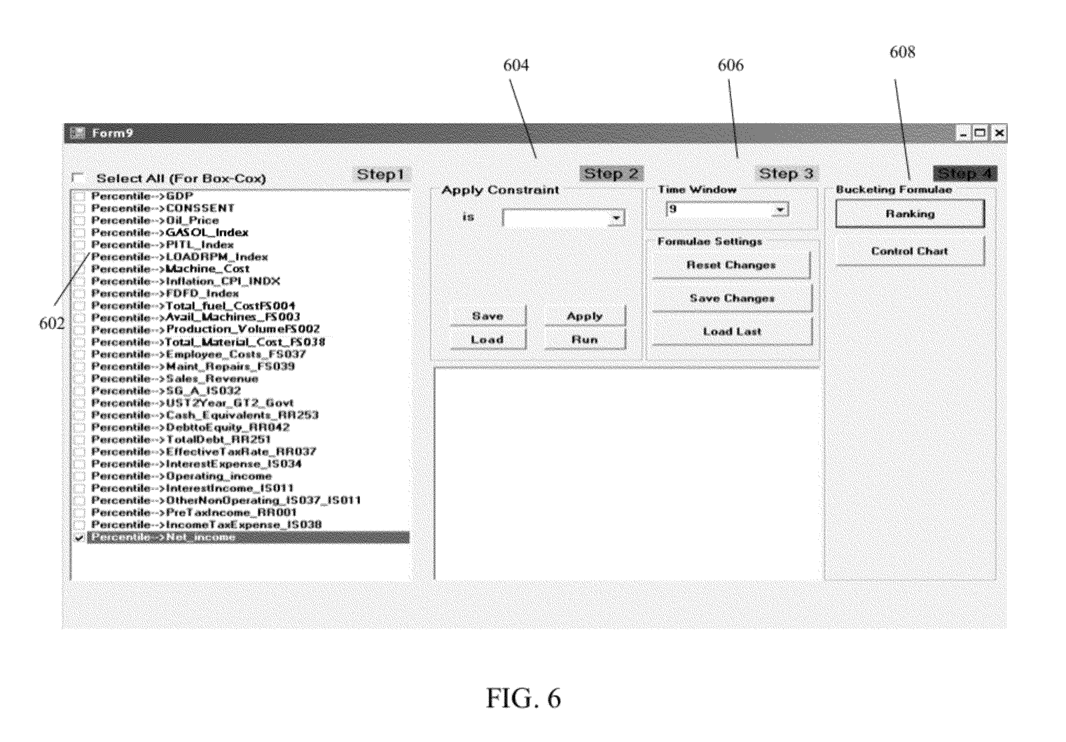

FIG. 6 is a screenshot illustrating discretization of Bayesian network performed by software tool, in accordance with an embodiment of the present invention. A business analyst can choose one or more parameters from a list of parameters 602 as pivot parameters and discretize them manually by applying constraints 604 and specifying time windows 606. After manually discretizing one or more pivot parameters, by pressing the ranking button 608, the tool performs automatic Information Gain based Discretization and transforms all operational parameters into discrete format.

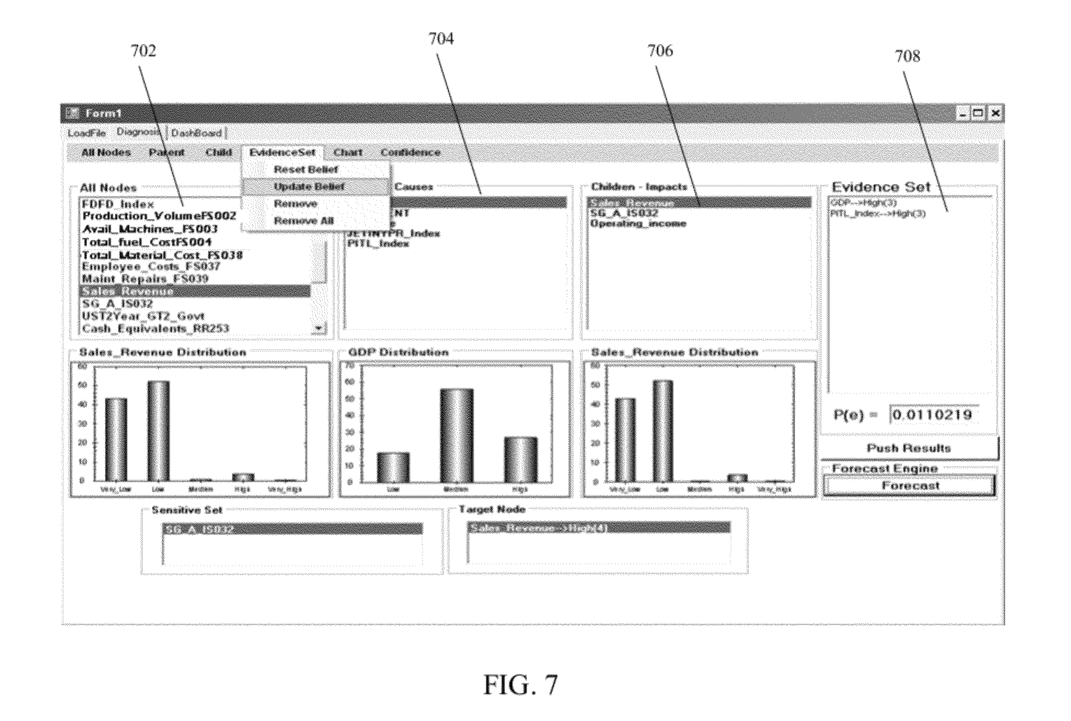

FIG. 7 is a screenshot illustrating performing inferences on Bayesian Engine. A business analyst may select a node from a list of nodes 702. Upon selecting a node, parent nodes 704 of the selected node as well as children nodes 706 are displayed. Also, an Evidence Set can be generated and supplied to the Bayesian Engine. As shown in the figure, an exemplary Evidence Set 708 with the operational parameters GDP and PITL_Index as ‘HIGH’ is generated and applied to the Bayesian Engine and corresponding probability distribution tables for Sales Revenue 710 are generated by the tool.

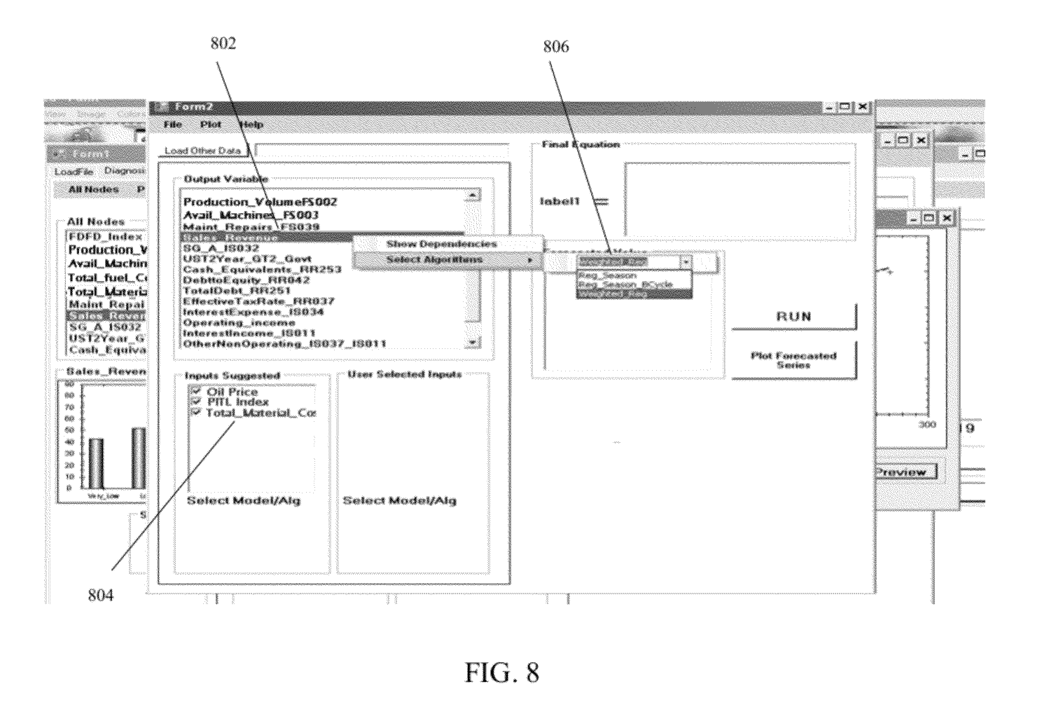

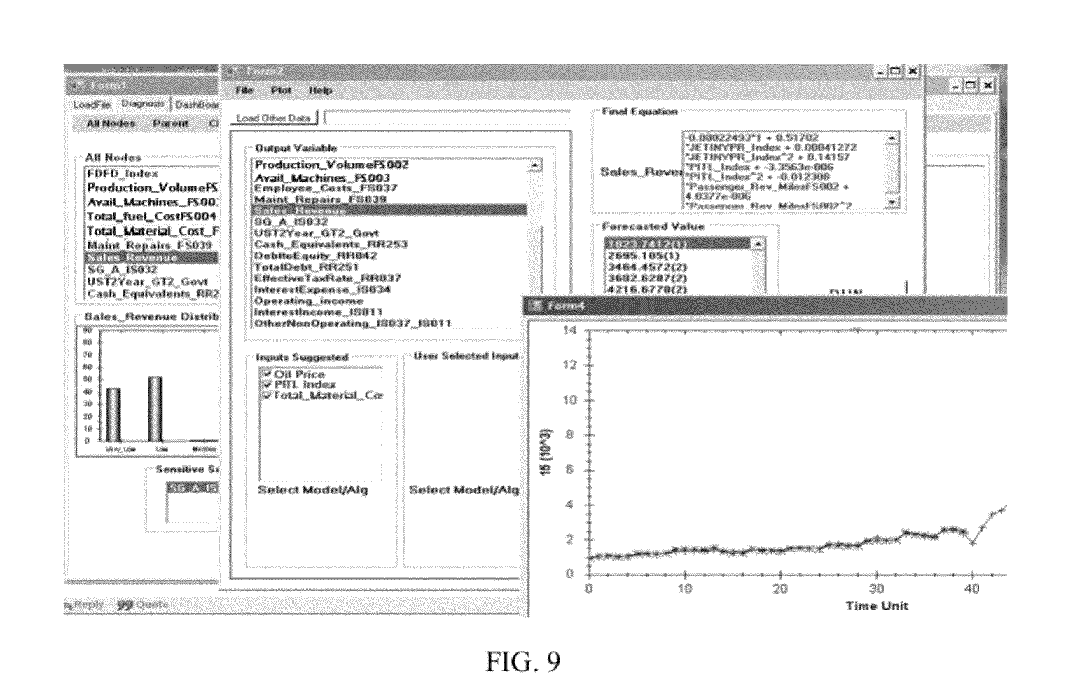

FIGS. 8 and 9 illustrate screenshots of a software tool implementing forecasting of values of operational parameters based on current market events. As shown in FIG. 8, a business analyst may select Sales Revenue 802 as targeted parameter and input parameters from list of parameters 804. Also, an appropriate algorithm such as Weighted Regression 806 can also be selected for performing the forecasting. FIG. 9 illustrate forecasted results based on running of the selected algorithm.

The method and system for estimation and analysis of operational parameters in workflow processes as described in the present invention or any of its embodiments, may be realized in the form of a computer system. Typical examples of a computer system include a general-purpose computer, a programmed microprocessor, a micro-controller, a peripheral integrated circuit element, and other devices or arrangement of devices that are capable of implementing the steps that constitute the method of the present invention.

The computer system typically comprises a computer, an input device, and a display unit. The computer typically comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions on the computer system.

The computer system executes a set of instructions that are stored in one or more storage elements to process input data. The storage elements may also hold data or other information, as desired, and may be an information source or physical memory element present in the processing machine. The set of instructions may include various commands that instruct the processing machine to execute specific tasks such as the steps constituting the method of the present invention.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A method for establishing the effect of one or more operational parameters on one or more critical operational parameters of an organizational workflow process, the method comprising:
collecting one or more operational parameters related to the workflow process, wherein the one or more operational parameters influence one or more critical parameters;
creating a Bayesian network comprising one or more operational nodes representing the one or more operational parameters and one or more critical nodes representing the one or more critical parameters;
creating one or more conditional probability tables corresponding to the one or more operational nodes and the one or more critical nodes;
generating a Bayesian engine using the Bayesian network structure;
generating an evidence set based on market events, wherein the evidence set comprises information on the one or more operational nodes along with their values;
deducing inferences based on the generated evidence set and the Bayesian engine, wherein the inferences are deduced by determining possible discrete states of operational parameters associated with one or more target nodes and their probability distribution values; and
validating the deduced inferences to confirm strength of probability distribution values.

2. The method of claim 1, wherein collecting one or more operational parameters related to the workflow process comprises extracting the one or more operational parameters from a database, wherein the one or more operational parameters comprises at least one of macroeconomic parameters, industry-specific parameters and organization-specific parameters.

3. The method of claim 2, wherein a Bayesian network comprising one or more operational nodes and one or more critical nodes is created using one or more industry standard templates stored in the database.

4. The method of claim 1, wherein generating a Bayesian engine using the Bayesian network structure comprises:
extracting a training dataset for populating conditional probability tables associated with each node of the Bayesian network;
filling up missing values in the training dataset based on mathematical regression techniques;
discretizing the one or more operational nodes and the one or more critical nodes; and
performing parameter learning of discrete dataset of each node for generating one or more conditional probability tables for a Bayesian engine.

5. The method of claim 4, wherein the one or more operational nodes and the one or more critical nodes are discretized using impurity based discretization method with dynamic programming based approach.

6. The method of claim 4, wherein parameter learning of discrete dataset of each node is performed by executing Maximum Likelihood Estimation method.

7. The method of claim 6 further comprising prior to generating an evidence set, the method comprises:
determining whether additional datasets are available for facilitating creation of a Bayesian network;
generating an intermediate conditional probability table for each operational node and each critical node;
updating the one or more conditional probability tables based on intermediate conditional probability tables and the existing Bayesian engine; and
updating the existing Bayesian engine based on the updated one or more conditional probability tables.

8. The method of claim 1 further comprising computing joint probability of generated evidence set in order to validate strength of evidence set.

9. The method of claim 1, wherein inferences are deduced by computing confidence limit of inference results for probability value of each state corresponding to a target node, wherein the confidence limit is computed by calculating conditional probability values of nodes which are immediate parent or child of the target node and the effect of conditional probability values on conditional probability table of the target node is determined.

10. The method of claim 1 further comprising:
determining whether forecasting is to be performed for a selected operational parameter;
collecting independent operational parameters from the Bayesian network for performing forecasting for the selected parameter;
obtaining probability distribution of independent parameters; and
performing forecasting for the selected parameter using Bayesian locally weighted regression model.

11. The method of claim 10, wherein the Bayesian locally weighted regression model is implemented using seasonality based forecasting algorithm.

12. The method of claim 10, wherein the Bayesian locally weighted regression model is implemented using seasonality based forecasting algorithm with business cycle.

13. A system for analysis of one or more operational parameters in an organizational workflow process in order to determine their effect on one or more critical parameters, the system comprising:
a database structured to store templates of Bayesian Networks corresponding to one or more business domains, wherein a template corresponding to a business domain is a probabilistic model including operational parameters specific to the business domain;
a Bayesian network module adapted to import an appropriate template from the database and customize the template to create a Bayesian network comprising a plurality of nodes corresponding to the one or more operational parameters and the one or more critical parameters, and further configured to generate conditional probability tables for the plurality of nodes;
a Data Processing Unit configured to convert operational parameters associated with the plurality of nodes into discretized variables;
an Incremental Learning Unit operationally connected to take inputs from the Data Processing Unit and containing software code adapted to use new records associated with organizational workflow for generating intermediate conditional probability tables corresponding to the plurality of nodes and further configured to update existing conditional probability tables based on the intermediate conditional probability tables;
a Network Troubleshooting Unit configured to incorporate information from training dataset for facilitating creation of Bayesian network; and
an Inference Unit configured to utilize evidence set generated from market events and information stored in conditional probability tables to deduce inferences for determining effect of one or more operational parameters on the one or more critical parameters.

14. The system of claim 13 further comprising a forecasting module operating to project current status and forecast future values of one or more parameters related to organizational workflow process based on current market events.

15. The system of claim 14, wherein forecasting of future values is performed using Bayesian locally weighted regression method.

16. The system of claim 13, wherein the inference unit deduces inferences using a Junction Tree Algorithm.

17. The system of claim 13, wherein operational parameters are converted into discretized variables using an impurity based discretization method.

18. A computer program product comprising a computer usable medium having a computer readable program code embodied therein for establishing the effect of one or more operational parameters on one or more critical operational parameters of an organizational workflow process, the computer program product comprising:
program instruction means for collecting one or more operational parameters related to the workflow process;
program instruction means for creating a Bayesian network comprising one or more operational nodes representing the one or more operational parameters and one or more critical nodes representing the one or more critical parameters;
program instruction means for creating one or more conditional probability tables corresponding to the one or more operational nodes and the one or more critical nodes;
program instruction means for generating a Bayesian engine using the Bayesian network structure;
program instruction means for generating an evidence set based on market events;
program instruction means for deducing inferences based on the generated evidence set and the Bayesian engine; and
program instruction means for validating the deduced inferences to confirm strength of probability distribution values.

19. The computer program product of claim 18, wherein the step of generating a Bayesian engine using the Bayesian network structure comprises:
program instruction means for extracting a training dataset for populating conditional probability tables associated with each node of the Bayesian network;
program instruction means for filling up missing values in the training dataset based on mathematical regression techniques;
program instruction means for discretizing the one or more operational nodes and the one or more critical nodes; and
program instruction means for performing parameter learning of discrete dataset of each node for generating one or more conditional probability tables for a Bayesian engine.

20. The computer program product of claim 19, wherein prior to the step of generating an evidence set, the computer program product comprises:
program instruction means for determining whether additional datasets are available for facilitating creation of a Bayesian network;
program instruction means for generating an intermediate conditional probability table for each operational node and each critical node;
program instruction means for updating the one or more conditional probability tables based on intermediate conditional probability tables and the existing Bayesian engine; and
program instruction means for updating the existing Bayesian engine based on the updated one or more conditional probability tables.

21. The computer program product of claim 18 further comprising program instruction means for computing joint probability of generated evidence set in order to validate strength of evidence set.

22. The computer program product of claim 18 further comprising:
program instruction means for determining whether forecasting is to be performed for a selected operational parameter;
program instruction means for collecting independent operational parameters from the Bayesian network for performing forecasting for the selected parameter;
program instruction means for obtaining probability distribution of independent parameters; and
program instruction means for performing forecasting for the selected parameter using Bayesian locally weighted regression model.
